(19) United States
(12) Patent Application Publication
(10) Pub. No.: US 2007/0266128 A1
(43) Pub. Date: Nov. 15, 2007

(54) METHOD AND APPARATUS FOR MONITORING DEPLOYMENT OF APPLICATIONS AND CONFIGURATION CHANGES IN A NETWORK OF DATA PROCESSING SYSTEMS

(76) Inventors: Kulvir Singh Bhogal, Fort Worth, TX (US); Alexandre Polozoff, Bloomington, IL (US)

Correspondence Address: IBM CORPORATION (SHC);C/O THE CULBERTSON GROUP, P.C., 1114 LOST CREEK BOULEVARD, SUITE 420, AUSTIN, TX, 78746, US

(21) Appl. No.: 11/382,628

(22) Filed: May 10, 2006

(51) Int. Cl. G06F 15/177; G06F 15/173

(52) U.S. Cl. 709/223; 709/220

(57) ABSTRACT

A method includes storing status information relating to the implementation of operational updates for various data processing systems in a network of such systems. The status information may be stored in the form of a log of various actions related to the implementation of the operational updates. In response to a monitoring request generated by a user interface process, a subset of the status information specified by the monitoring request is collected and displayed at a display device. The subset of status information is displayed in a form specified by the user interface process, and may include a series of operational update items, each item associated with a respective data processing system which is to implement a respective operational update. This method allows a network administrator to conveniently view a desired subset of the status information to monitor the implementation of the operational updates.

### CROSS-REFERENCE TO RELATED APPLICATIONS

The present application is related to co-pending U.S. patent application Ser. No. 11/104,258, entitled “METHOD AND APPARATUS TO GUARANTEE CONFIGURATION SETTINGS IN REMOTE DATA PROCESSING SYSTEMS” filed on Apr. 12, 2005, and to co-pending U.S. patent application Ser. No. 11/249,932, entitled “METHOD AND APPARATUS TO PROVIDE GUARANTEED DEPLOYMENT OF APPLICATIONS TO NODES IN AN ENTERPRISE” filed on Oct. 13, 2005. The entire content of each of these applications is incorporated herein by this reference.

### TECHNICAL FIELD OF THE INVENTION

The present invention relates generally to data processing in a network environment. More particularly, the present invention provides a method, system, and computer program product for enabling a user to examine the deployment status of applications and configuration changes in a network of data processing systems.

### BACKGROUND OF THE INVENTION

Data processing systems such as computer systems are commonly connected in networks that facilitate communications between the various data processing systems. The ability to communicate across a network allows different data processing systems to share data files, share various resources such as printers and mass data storage devices, for example, and to cooperate in performing data processing operations. Data processing systems at a single geographic location may be connected in a local area network (LAN), while various LANs and data processing systems at different geographic locations may be connected in a wide area network (WAN). Networks of data processing systems may be private, utilizing private communication lines and wireless links, and may also employ public infrastructure such as that used in the Internet.

In addition to providing access to data and resources, a data processing system network facilitates centralized administration of the various data processing systems included in the network. For example, software programs residing at different data processing systems in a network may be updated, replaced, or reconfigured across the network without having to send technicians to the particular data processing systems.

Although the ability to modify software programs operating at remote data processing systems in a network facilitates centralized maintenance and administration, it does raise its own set of issues and problems. This is particularly the case in complex networks in which groups of data processing systems cooperate in data processing tasks. An example of a relatively complex network arrangement in which groups of data processing systems cooperate in data processing tasks is an arrangement commonly referred to as a “server cluster.” In a server cluster, multiple data processing systems, which are individually referred to as “servers,” may concurrently handle transactions or requests from various client data processing systems to a common network address. In server clusters, a modification to the software executed at one server must also be made at the other servers in order to provide consistent operation. However, if a given server is not operating at a time when a software modification is distributed, that server will not receive the software modification. When the server again becomes operational it will then not operate consistently with the servers that have properly received and implemented the software modification. The server not receiving and implementing the software modification is said to be out of synchronization with the rest of the servers.

The related patent applications referenced above address this problem of synchronization between different data processing systems by providing methods, apparatus, and computer instructions for guaranteeing installation of software modifications and configuration changes in a set of data processing systems. The present invention addresses the problem of monitoring the status of software modifications and configuration changes in a set of data processing systems. The present invention also facilitates further administrative changes in the course of distributing software modifications and configuration changes in a set of data processing systems.

### SUMMARY OF THE INVENTION

The present invention provides methods, apparatus, and program products for enabling a network administrator to conveniently monitor the implementation of software modifications and configuration changes in various data processing systems included in a network of data processing systems. The present invention also provides methods, apparatus, and program products for allowing a network administrator to conveniently make additional modifications in the course of implementing various software modifications and configuration changes in a network of data processing systems.

As used in this disclosure and the accompanying claims, software additions and deletions, and any other modifications of application software, operating system software, or other software or program instructions or resources, as well as configuration changes in application software, operating system software, or other program instructions or resources, will be referred to as operational updates. The implementation of operational updates will refer not only to the distribution of such updates to various target data processing systems in the network, but also to the installation or entry of the operational updates to affect the configuration or operation of the various target data processing systems.

One preferred method embodying the principles of the present invention includes storing status information relating to the implementation of operational updates for various data processing systems in a network of such systems. For example, the status information may be stored in the form of a log of various actions related to the implementation of the operational updates. This preferred method also includes receiving a monitoring request generated by a user interface process. In response to the monitoring request, this preferred method includes collecting a subset of the status information which is specified by the monitoring request, and displaying the subset of the status information at a display device. The subset of status information is displayed in a form specified by the user interface process, and may include a series of operational update items, each item associated with a respective data processing system to implement the respective operational update. This method allows a network administrator to conveniently view a desired subset of the status information to monitor the implementation of the operational updates.

Where one or more pending operational updates are displayed, this preferred method may additionally include receiving an item selection input which is entered through the user interface process and which specifies a particular one of the operational update items for a respective one of the data processing systems. A modification input may then be received through the user interface process, and this modification input may specify a modification to an aspect of the particular operational update item that is specified by the item selection input. The method may further include modifying the operational update item according to the modification specified by the modification input. This modification to the operational update item modifies some aspect of the operational update itself. Thus, the present invention not only provides a convenient method for enabling a network administrator to view the status of various operational updates, but also provides a convenient method for modifying operational updates for specific data processing systems as necessary or desirable.

One preferred form of apparatus embodying the principles of the present invention includes an update status storage device and a user interface system. The update status storage device stores status information relating to the implementation of operational updates for various data processing systems in a network of such systems. The user interface system generates the monitoring request as described above, and collects the specified subset of status information from the update status storage device. The user interface system then causes the subset of the status information to be displayed at a suitable display device associated with the user interface system. A modification controller may also be included in the apparatus for making a modification to an aspect of an operational update item that is included in the subset of status information displayed at the display device.

A program product according to the present invention includes program code that may be executed by a suitable data processing system or systems to implement a method according to the present invention. One preferred program product includes status storage program code, user input program code, and view processing program code. The status storage program code is executable for causing the above-described status information to be stored in a data storage device. The user input program code is executable for generating a monitoring request which specifies a subset of the status information as described above. The view processing program code is executable for collecting the subset of the status information specified in the monitoring request, and for causing the subset of the status information to be displayed at a display device. Modification program code may also be included in a program product according to the present invention. This modification program code is responsible for producing a modification to an operational update item in response to suitable inputs by a user.

These and other advantages and features of the invention will be apparent from the following description of the preferred embodiments, considered along with the accompanying drawings.

### BRIEF DESCRIPTION OF THE DRAWINGS

FIG. 1 is a representation of a network of data processing systems in which the present invention may be implemented.

FIG. 2 is a diagram of a server cluster for which operational updates may be monitored in accordance with preferred embodiments of the present invention.

FIG. 3 is a block diagram of a server data processing system that may be employed in a preferred embodiment of the present invention.

FIG. 4 is a block diagram of a client data processing system that may be employed in a preferred embodiment of the present invention.

FIG. 5 is a block diagram of an arrangement for making operational updates that may be monitored in accordance with preferred embodiments of the present invention.

FIG. 6 is a flowchart showing a process for displaying a desired subset of operational update information in accordance with a preferred embodiment of the present invention, and for modifying a desired operational update.

FIG. 7 is a representation of a graphical user interface that may be employed in a preferred embodiment of the present invention.

FIG. 8 is a graphical user interface representation similar to that shown in FIG. 7, but also showing a series of operational update items according to one preferred form of the invention.

### DESCRIPTION OF PREFERRED EMBODIMENTS

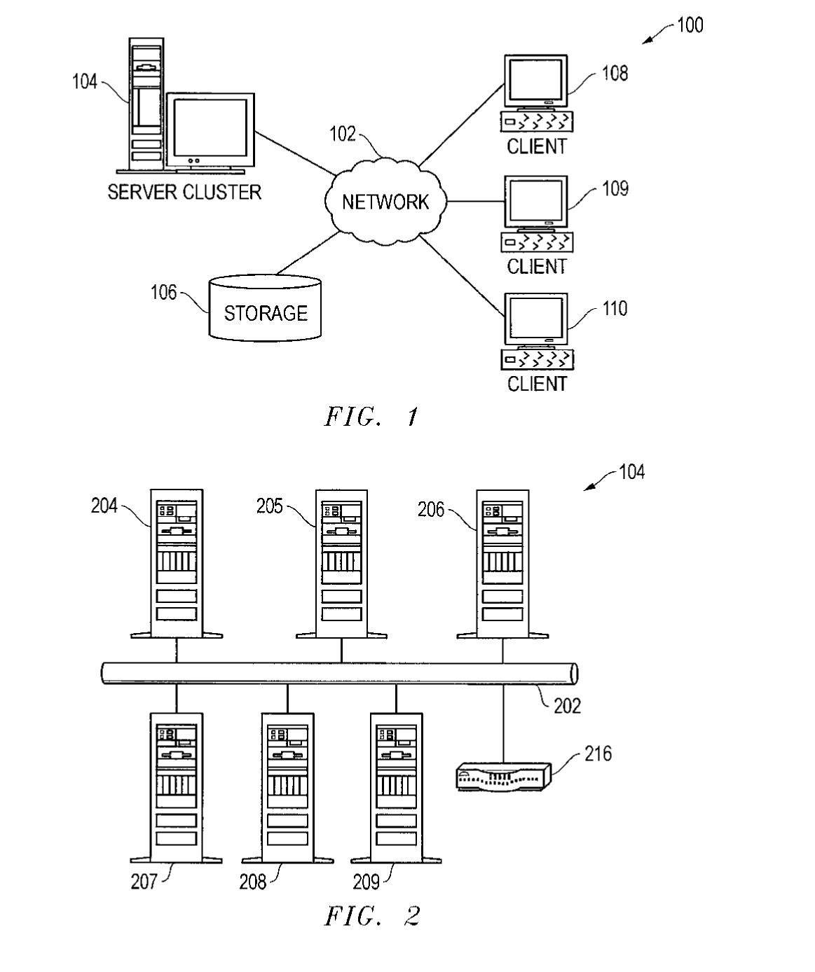

FIG. 1 depicts a data processing system network 100 in which the present invention may be implemented. Data processing system network 100 contains a communications network 102 providing communications links between various devices and computers connected together within data processing system network 100. Communications network 102 may include one or more or various types of communications links, such as wired communication links, wireless communication links, or fiber optic communication links. In one embodiment, communications network 102 can include a WAN such as the Internet. Of course, communications network 102 may alternatively or additionally include other networks, for example, an intranet or a LAN.

In the depicted example, a server cluster 104, storage unit 106, and clients 108, 109, and 110 are connected to communications network 102. Clients 108, 109, and 110 may be, for example, personal computers or network computers. Server cluster 104 may provide data, such as boot files, operating system images, and applications to clients 108-110. Data processing system network 100 may include additional servers, clients, and other devices not shown. FIG. 1 is intended as an example to provide a context for describing the present invention, and not as an architectural limitation for the present invention.

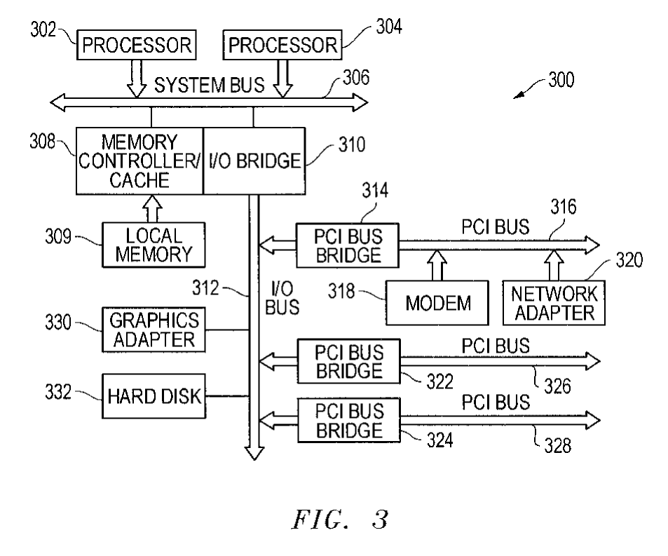

FIG. 2 is a diagram showing further details of server cluster 104 shown in FIG. 1. Server cluster 104 contains a communications arrangement 202 which facilitates communications to and from and between server data processing systems 204, 205, 206, 207, 208, and 209. Communications arrangement 202 may comprise, for example, a bus, an Ethernet network, or any other suitable communications arrangement or combination of communications arrangements.

A traffic scheduler 216, such as a router, is also connected to communications arrangement 202. Although shown as a separate physical component, traffic scheduler 216 may alternatively be a logical construct distributed within one or more of servers 204-209 in server cluster 104. Traffic scheduler 216 receives initial requests from clients such as clients 108-110 shown in FIG. 1. Load balancing algorithms and/or other policies may be used to direct each such initial request to one of the servers 204-209 in server cluster 104. Subsequent requests by a client may be handled by traffic scheduler 216, or alternatively, may be handled directly by the server 204-209 which handled the initial request. The initial request together with the subsequent related requests may be referred to as a “session” or “user session.”

Each of the servers 204-209 may comprise a data processing system such as system 300 shown in FIG. 3. Data processing system 300 may be a symmetric multiprocessor (SMP) system including a plurality of processors 302 and 304 that each connects to a system bus 306. Also, a memory controller/cache 308 connects to system bus 306 and provides an interface to local memory 309. I/O bus bridge 310 connects to system bus 306 and provides an interface to I/O bus 312. Memory controller/cache 308 and I/O bus bridge 310 may be integrated as depicted. Peripheral component interconnect (PCI) bus bridge 314 also connects to I/O bus 312 and provides an interface to PCI local bus 316. Devices such as a modem 318 and network adapter 320 may be connected to PCI local bus 316. Network adapter 320 may provide a communications connection to communications arrangement 202 in FIG. 2, which in turn facilitates communications to clients 108-110 in FIG. 1 via network 102. Additional PCI bus bridges 322 and 324 provide interfaces for additional PCI local buses 326 and 328, from which additional network adapters (for connections to additional networks) or other devices may be supported. Data processing system 300 also includes a graphics adapter 330 and hard disk 332 connected either directly or indirectly to I/O bus 312.

Those of ordinary skill in the art will appreciate that the hardware for the various servers 204-209 shown in FIG. 2 may vary from the example system 300 depicted in FIG. 3. For example, other peripheral devices, such as optical disk drives and the like, may also be included in system 300. The illustrated example system 300 is not meant to imply architectural limitations with respect to the present invention.

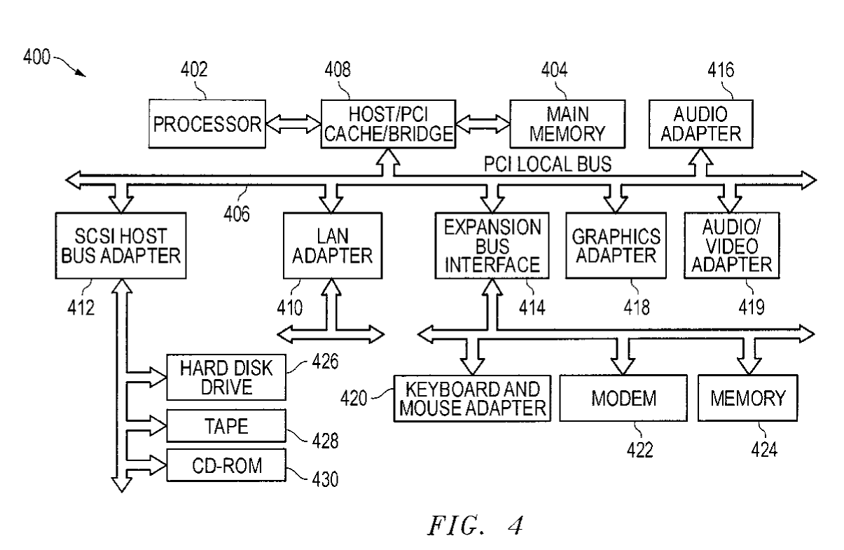

The block diagram shown in FIG. 4 illustrates a data processing system 400 that may comprise one of the client computers 108, 109, or 110 shown in FIG. 1. Data processing system 400 employs a peripheral component interconnect (PCI) local bus architecture in which a number of system components connect to a PCI local bus 406. In particular, processor 402 and main memory 404 connect to PCI local bus 406 through PCI bridge 408. PCI bridge 408 also may include an integrated memory controller and cache memory for processor 402. In the illustrated example, a local area network (LAN) adapter 410, small computer system interface (SCSI) host bus adapter 412, expansion bus interface 414, audio adapter 416, graphics adapter 418, and audio/video adapter 419 connect to PCI local bus 406 by a suitable connection, either by direct component connection or by expansion slot. Expansion bus interface 414 connects to a keyboard and mouse adapter 420, modem 422, and additional memory 424. SCSI host bus adapter 412 connects to hard disk drive 426, tape drive 428, and CD-ROM drive 430.

Client computers such as clients 108, 109, and 110 in FIG. 1 are by no means limited to data processing systems having the particular hardware configuration of system 400 shown in FIG. 4. Rather, client computers 108, 109, and 110 may utilize any suitable hardware arrangement. Other internal hardware or peripheral devices, such as flash read-only memory (ROM), other nonvolatile memory, or optical disk drives and the like, may be used in addition to or in place of certain hardware components shown in FIG. 4. Also, the PCI bus 406 is merely shown in FIG. 4 as an example of a bus that may be employed in a client computer. Other bus architectures such as Accelerated Graphics Port (AGP) and Industry Standard Architecture (ISA) may be used in lieu of or in addition to the PCI bus shown in FIG. 4. It will also be appreciated that a client such as clients 108, 109, or 110 shown in FIG. 1 may comprise a notebook computer having an architecture similar to that shown in FIG. 4, or a hand held computer, PDA, kiosk computer, a Web appliance, or a multiprocessor data processing system such as data processing system 300 of FIG. 3.

Regardless of the particular architecture used for a given server data processing system 204-209 shown in FIG. 2 or client data processing system 108-110 shown in FIG. 1, each of these data processing systems will typically execute a suitable operating system program and numerous software applications. The particular operating system employed by any of these data processing systems and the various software applications executed may each be updated with new programs or program components and may be configured in any number of fashions suitable for the particular tasks to be performed by the particular data processing system. Also, many hardware and software configuration settings in the particular data processing system may be modifiable by software instruction, either through the operating system program or through one or more applications.

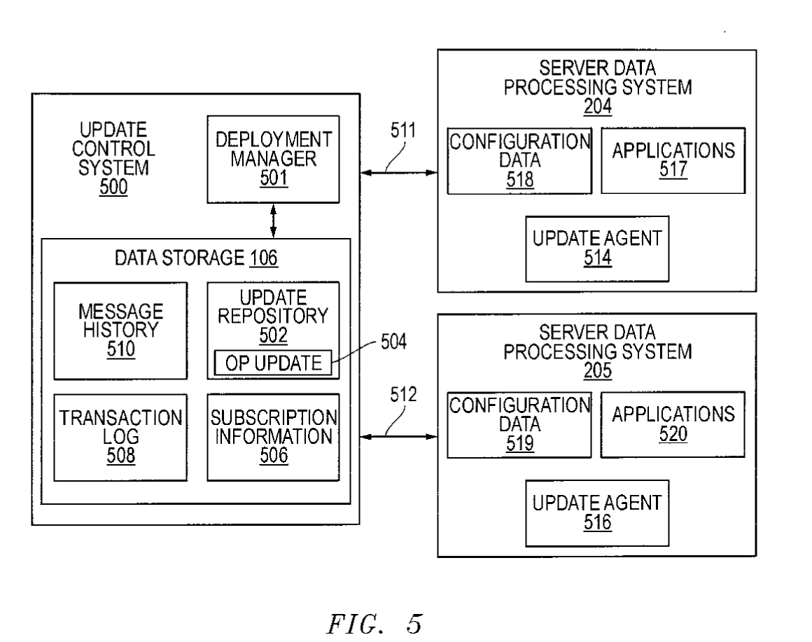

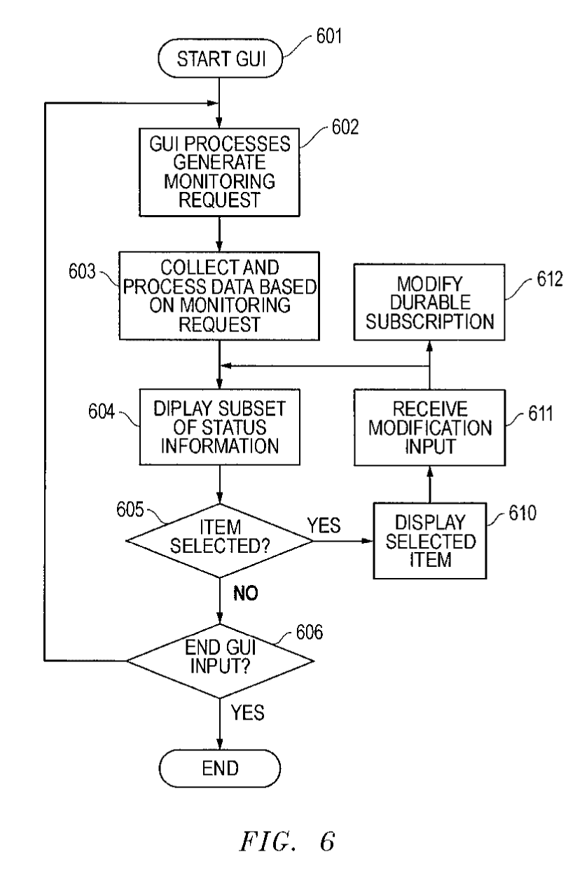

The present invention facilitates monitoring software and configuration changes (that is, operational updates as previously described) in the various data processing systems in the example data processing network 100 shown in FIG. 1. One preferred form of the present invention operates in connection with a system which ensures that operational updates are implemented at the intended data processing systems. FIG. 5 will be used to first describe this operational update control arrangement in the context of server data processing systems such as systems 204-209 shown in FIG. 2. Then FIGS. 6-8 will be used to describe preferred arrangements for enabling a network administrator or other authorized users to monitor operational updates or to modify pending operational updates as desired.

FIG. 5 is a diagram of components that participate in a system for ensuring the proper implementation of operational updates at a number of server data processing systems such as the systems 204-209 shown in FIG. 2. The illustrated system for ensuring the proper implementation of operational updates comprises an update control system 500 including a deployment manager 501 and a suitable data storage arrangement, shown in FIG. 5 as the data storage 106 also shown in FIG. 1. In order to simplify the discussion, FIG. 5 is limited to only two of the server data processing systems from the server cluster made up of systems 204-209. In particular, FIG. 5 shows only server data processing systems 204 and 205, which are connected for communication with update control system 500 across communications connections 511 and 512, respectively. However, it will be appreciated that update control system 500 is preferably configured to ensure proper updating in all of the server data processing systems in server cluster 104. Also, an update control system such as system 500 shown in FIG. 5 may be configured to ensure proper updating in data processing systems throughout an entire network such as that shown in FIG. 1, or a segment of such a network.

Deployment manager 501 comprises a collection of processes performed at one or more suitable data processing systems. These processes are preferably performed through operational program code executed at the suitable data processing system or systems. For example, processes making up deployment manager 501 may be performed at any of the server data processing systems 204-209 in the server cluster shown in FIG. 2. Alternatively, the processes making up deployment manager 501 may be performed at a data processing system external to server cluster 104 shown in FIGS. 1 and 2. The processes included in deployment manager 501 include a process that distributes operational updates to various data processing systems, including server systems 204 and 205, preferably based on a durable subscription service. A durable subscription service functions to hold a message for a subscribing target system in the event the target system is unable to receive the message when it is originally sent, and then resends the held message when the subscribing target system is once again available for receiving the message. Deployment manager 501 also includes a logging process that maintains a log of transactions associated with the implementation of operational updates.

Deployment manager 501 utilizes various types of information in connection with the implementation of operational updates, and also generates various types of data for use in accordance with the present invention and otherwise. This information is stored in a suitable storage device or set of storage devices. FIG. 5 shows the storage device used by update manager 501 to be storage device 106 shown in FIG. 1. However, it will be appreciated that any suitable storage device may be used by deployment manager 501, including storage available locally at the particular data processing system or systems at which the deployment manager is implemented. In any event, the storage device used by deployment manager 501 stores an update repository 502 which includes various operational updates 504 to be distributed by the deployment manager. The storage device used by deployment manager 501 also stores subscription information 506, a transaction log 508, and a message history 510.

Subscription information 506 is part of a durable subscription service and includes information to correlate various operational updates or types of such updates to the various data processing systems to be updated (such as server data processing systems 204 and 205) so that each data processing system receives the appropriate operational updates. For example, subscription information 506 may correlate an operational update affecting application X to the various data processing systems that may locally store and execute application X.

Transaction log 508 preferably contains a log entry for each transaction involving the implementation of an operational update through deployment manager 501. Thus, transaction log 508 effectively stores and maintains information relating to the status of operational updates implemented through deployment manager 501. As will be described further below, the present invention uses this status information relating to the implementation of operational updates in producing a display showing the status of various operational updates. The present invention is not limited to any particular transaction log 508 provided that the log, or the transaction log together with information stored external to the transaction log, stores sufficient status information regarding the implementation of operational updates to produce the desired status views described below in connection with FIGS. 6-8. Also, the invention is not limited to any particular format for transaction log 508 provided the format facilitates the extraction of information necessary to produce the desired status views described below.

Message history 510 is used by deployment manager 501 to store messages that are published or sent to a subscriber data processing system (such as server system 204 or 205) while such system is disconnected or is otherwise unavailable for receiving the message. Deployment manager 501 then delivers these stored messages when the particular subscriber data processing system again becomes available for receiving the message.

As shown in FIG. 5, server data processing system 204 executes an update agent 514, and server data processing system 205 similarly executes an update agent 516. These update agents comprise programs that, when executed at the respective server data processing system, cooperate with deployment manager 501 to ensure the applications and configuration settings used by the respective server data processing system are updated properly. In particular, update agent 514 executed by server data processing system 204 participates in handling operational updates that affect applications 517 and configuration data 518 used by system 204. Update agent 516 executed by server data processing system 205 participates in handling operational updates that affect applications 520 and configuration data 519 used by system 205.

The update control system 500 shown in FIG. 5 is preferably implemented to ensure that the desired subscribing data processing systems each receive and install the desired operational updates. For example, assume server data processing system 204 is unavailable at the time an operational update is distributed by deployment manager 501, and thus does not return a reply to the distribution of an operational update such as update 504. In this case deployment manager 501 places the identification of that server data processing system and the undelivered message into message history 510. When server data processing system 204 again becomes available, update agent 514 announces the availability of system 204 to deployment manager 501, using a suitable message sent to the deployment manager via a suitable network connection such as 511. In response to the message sent by update agent 514, deployment manager 501 checks message history 510 to determine whether any undelivered operational updates are present for server data processing system 204. In this illustrative example, deployment manager 501 locates the undelivered message regarding operational update 504. In response to identifying the undelivered message regarding operational update 504, deployment manager 501 sends the undelivered operational update 504 to server data processing system 204 over a suitable connection such as connection 511. Server data processing system 204 receives operational update 504, installs, or otherwise activates the operational update, and then sends an acknowledgment back to deployment manager 501 to acknowledge that the operational update has been implemented.

The example in the preceding paragraph assumes that operational update control system 500 pushes operational updates to the various subscribing data processing systems. That is, operational updates are pushed to the subscribing data processing systems both at the time the operational updates are initially distributed and subsequently where a subscribing data processing system is unavailable at the time of the initial distribution. It will be appreciated that other implementations of operational update control system 500 may rely on the various subscribing data processing systems such as server system 204 and 205 to check at appropriate times for operational updates available through system 500. The subscribing data processing systems may be configured to then cause the applicable operational updates to be distributed from operational update control system 500. That is, the various subscribing data processing systems may be configured to pull the appropriate operational updates from operational update control system 500.

It will be appreciated that operational updates such as those implemented through the update control system 500 shown in FIG. 5 may be in any one of a number of different states at any given point in time. For example, an operational update for a given data processing system may remain in a pending state for some period of time after the update control system begins the process of distributing the operational update. Once an operational update is acknowledged as being installed or otherwise activated by a given data processing system, the status of the operational update for that data processing system may be changed from pending to completed. The status of a given operational update may also be described at various intermediate levels between “pending” and “completed,” and/or there may be some error associated with a given operational update for a given data processing system in which case the status of the operational update may be identified as an error status.

The present invention enables a system administrator or other authorized user to conveniently see the status of various operational updates in an operational update system such as that described in connection with FIG. 5, and make certain changes to operational updates for certain target systems. An example process embodying the principles of the invention is shown in FIG. 6. This process employs a user interface system, and particularly a graphical user interface (GUI), through which various requests associated with operational updates may be generated and through which the status of various operational updates in an operational update system may be displayed. As used herein, the designation “GUI” refers to the graphical display and various graphical features included in the overall display which are used to provide an interface to the various functions available to a user according to the present invention. It will be appreciated that these graphical displays and graphical display features are generated under the control of operational program instructions. These program instructions which are executed to cause the GUI to be displayed and which receive and act on user commands entered through the GUI will be referred to herein as GUI processes.

Referring now to FIG. 6, the GUI processes are first started as indicated at process block 601. The GUI processes include processes performed at a particular data processing system in the network such as a client data processing system 108-110 in FIG. 1, or one of the server data processing systems 204-209 shown in FIG. 2. The GUI processes also include processes that are performed at least in part at a data processing system having access to the operational update status information to the extent another data processing system is required or useful in providing such access. For example, some GUI processes may be performed by the same data processing system that performs the processes making up deployment manager 501 in FIG. 5, or certain GUI processes may be considered part of the deployment manager.

In response to a user input, or in some other fashion as will be discussed further below, the GUI processes generate a monitoring request as indicated at process block 602. Regardless of the specific manner in which the monitoring request is generated, the monitoring request specifies a subset of status information relating to the implementation of operational updates for respective data processing systems in a network of such systems. In response to the monitoring request generated at process block 602, the illustrated example process includes collecting and processing data based on the monitoring request as shown at process block 603. This data is ultimately used to display operational update status information through the GUI. This display step is shown at process block 604. Assuming that no displayed item is selected for modification as indicated at decision block 605, the process either loops back to wait for another monitoring request at process block 602, or terminates if an input has been entered to end the GUI. These looping and terminating alternatives are indicated at decision block 606 in FIG. 6.

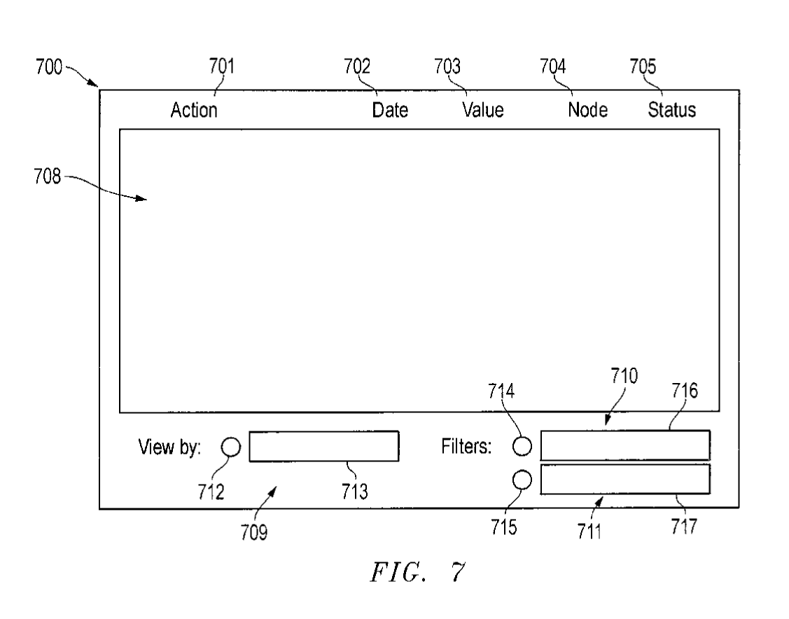

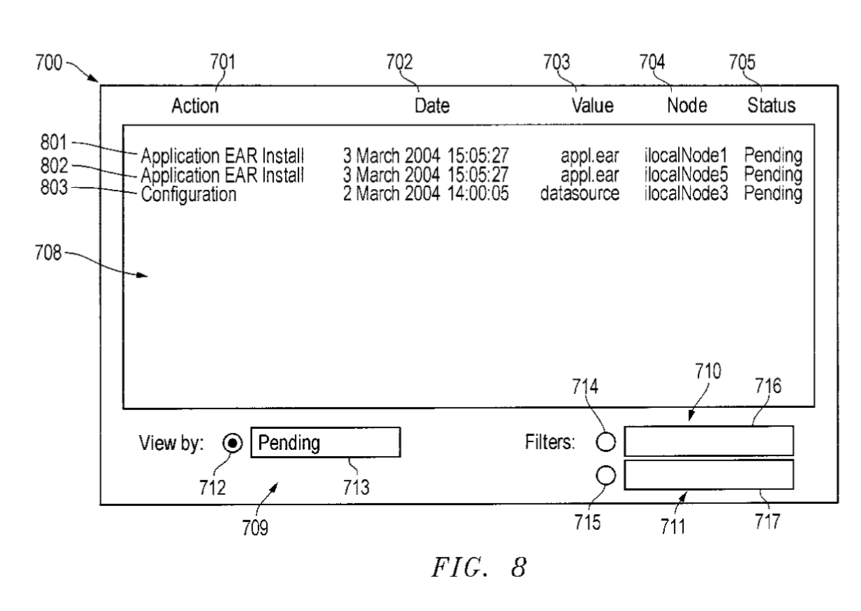

The example GUI 700 shown in FIGS. 7 and 8 may be used to describe a specific example of the processes indicated at process blocks 601 through 606 in FIG. 6. FIG. 7 shows GUI 700 in an initial condition that may occur in some preferred forms of the invention prior to the generation of a monitoring request as indicated at process block 602 in FIG. 6. GUI 700 includes a series of column labels 701 through 705, together with an area 708 directly below the column labels. This area 708 is reserved for showing a subset of status information relating to the implementation of operational updates for one or more data processing systems in a network. In this particular example GUI 700, area 708 is reserved to display a series of operational update items (“items”) as will be described further below in connection with FIG. 8. GUI 700 also includes a “view by” control 709 which may be invoked by a user to limit the items displayed in area 708 to those having a certain status value. Example GUI 700 also includes two filter controls 710 and 711 which may be invoked to further limit the items displayed in area 708. “View by” control 709 is illustrated as including an activator 712 and a value box 713. Activator 712 serves as a switch to invoke “view by” control 709, and value box 713 is used to display the particular status value to which the displayed items are to be limited. Value box 713 may be associated with a pull-down or pop-up menu that includes a list of available status values. For example, the available status values may include “pending,” “completed,” and “error.” Filter controls 710 and 711 also each include an activator, 714 and 715, respectively, and a value box 716 and 717, respectively. As with activator 712 for “view by” control 709, activators 714 and 715 may be toggled from an inactive condition to an active condition to invoke the respective control. Filter value boxes 716 and 717 may each be associated with a pull-down or pop-up menu which provides a number of alternative filter parameters that may be selected. Alternatively or additionally, any of the value boxes 713, 716, and 717 may accept manually entered values.

FIG. 8 shows GUI 700 after the GUI processes generate a monitoring request as indicated at process block 602 in FIG. 6, after the data specified by a monitoring request has been collected and processed as indicated at process block 603, and after the resulting subset of status information has been displayed as indicated at process block 604 in FIG. 6. In particular, the example shown in FIG. 8 indicates that “view by” control 709 has been invoked to show items having a value of “pending.” That is, the indicator in activator 712 shows that “view by” control 709 is active and the value “pending” appears in value box 713. In the example of FIG. 8, neither filter control 710 nor filter control 711 is invoked. Thus, the condition of the controls 709, 710, and 711 in FIG. 8 indicates that the view displayed in area 708 is to be limited to any operational update items having a status of “pending.” This requested limited view of operational update information correlates to a monitoring request generated as indicated at process block 602 in FIG. 6. In response to the condition of controls 709, 710, and 711 in FIG. 8, and the corresponding monitoring request generated by the GUI processes in view of the condition of these controls, the desired operational update information is collected and processed as indicated at process block 603 in FIG. 6, and displayed in area 708. This display step corresponds to the display step shown at process block 604 in FIG. 6.

In the example of FIG. 8, the displayed subset of operational update status information is made up of items 801, 802, and 803. Each item 801, 802, and 803 includes a descriptive action value under “Action” label 701, a timestamp value under “date” label 702, a source value under “value” label 703, a node identifier under “node” label 704, and a status value under “status” label 705. The timestamp value may represent the time that the operational update was distributed, and the source value may indicate the source for the operational update. The node value may represent the node (particular data processing system) which is to receive the operational update associated with that item, and the status value represents the status of particular operational update item, which, in this case, is “pending” corresponding to the status value specified in “view by” control 709. Item 801 in the example of FIG. 8 is for an application EAR file (enterprise archive file) install as indicated under “action” label 701, having a particular distribution timestamp value under “date” label 702, and having the source file “appl.ear” shown under “value” label 703. Item 801 is associated with the particular node “ilocalNode1” shown under “node” label 704. Item 802 shown in FIG. 8 is for the same application ear file install but in this case for a different node in the network. Example item 803 in FIG. 8 happens to be a configuration update as indicated by the designation “Configuration” under “action” label 701. This, configuration operational update shown at item 803 in FIG. 8 is associated with its respective distribution timestamp value, “datasource” for the data representing the configuration change, respective node identified as “ilocalNode3,” and, of course, the status “pending.”

It will be appreciated that if “view by” control 709 had been invoked to show completed operational update items, a different set of such items would have been displayed in space 708, and the status of each such entry may be shown as “completed.” Similarly, if “view by” control 709 is invoked to specify only items associated with an error, only operational update items having the status “error” would be displayed in space 708. It will also be appreciated that in the example GUI 700 shown in FIGS. 7 and 8, numerous different filter combinations could be employed with the filter controls 710 and 711 to further limit the operational update items, and thus the subset of operational update information, displayed in display area 708. For example, along with “view by” control 709 set to “pending” as shown in FIG. 8, filter control 710 could be invoked to limit the items to be displayed to only those items associated with a particular network node, or a particular action description, or a particular date. All of these combinations of controls correlate to the generation of a particular monitoring request as indicated at 602 which ultimately results in the display of the desired subset of operational update status information in GUI display area 708.

It should be appreciated that the example GUI 700 shown in FIGS. 7 and 8 is shown only for purposes of example and is not intended to impose any limitations on the graphics that may be employed according to the present invention. Rather, numerous variations in GUI 700 may be used within the scope of the present invention. For example, the various controls shown at 709, 710, and 711 may be presented differently and additional or fewer controls may be available to the user. Also, numerous different types of labels may be used to label the various values associated with the operational update items displayed in display area 708, and more or fewer values for a given item could be displayed. The labels and number of values presented to a user through the GUI as well as the relative positions of the various values, could also be configurable by the user. Display area 708 itself could be displayed differently than shown in the example of FIGS. 7 and 8.

The operations associated with starting GUI 700 as shown at process block 601 in FIG. 6 will depend upon the specific manner in which the GUI processes are implemented in the particular embodiment of the invention. In one preferred form of the invention, the GUI processes comprise Internet accessible processes that are hosted by a suitable server data processing system such as any one or more of the server data processing systems 204-209 shown in FIG. 2. In this implementation, a user may direct their Internet browser program to a hosting Internet address, and the GUI, such as GUI 700 shown in FIGS. 7 and 8 would represent a web page. In another preferred embodiment a program running at a data processing system in the network may include an icon or other control that may be selected by the user to invoke a web browser program at the data processing system and direct the web browser to the web page which produces the GUI such as GUI 700. Other implementations of the invention may use an independent program at a data processing system in the network to generate the GUI 700 and cooperate with processes running at one or more other data processing systems in the network to display the operational update status information as shown in the example of FIG. 8.

The example GUI 700 shown in FIG. 7 assumes that the GUI starts in a “blank” condition in which none of the controls 709, 710, or 711 are activated and no information is shown in area 708. In this form of the present invention, the step of generating a monitoring request as shown at process block 602 is performed in response to activating one or more of the controls 709, 710, and 711, and perhaps invoking another control such as a “Go” or “Refresh” control not shown in FIGS. 7 and 8. In other forms of the invention, the GUI processes may be configured to show a default view on start up of the GUI processes, in which one or more of the controls 709, 710, and 711 may be automatically activated with some default value selected in the respective control box. For example, GUI 700 may be configured so that the “view by” control is activated on start up to show all items having a “pending” status. Regardless of whether a monitoring request is generated manually by activating one or more of the GUI view controls, such as controls 709, 710, and 711 in example GUI 700, or automatically upon start up of the GUI processes or otherwise, each monitoring request generated by the GUI processes will include some information or value by which a subset of the available status information is specified. In the example GUI 700, the values that may be included in the monitoring request to specify a subset of available status information includes a status value that may be specified by “view by” control 709, and two filter values that may be specified by the two filter controls 710 and 711. Also, it will be appreciated that whether a monitoring request is generated automatically in some fashion or manually by a user invoking the various GUI controls, the GUI processes that ultimately generate the monitoring request are preferably performed under the control of suitable program code, which may be referred to as user input program code.

The data collection and processing step shown at process block 603 in FIG. 6 may be performed in any suitable fashion within the scope of the present invention. In each implementation, however, the collection will include collecting data necessary to show the desired subset of operational update status information specified by the monitoring request, and the collected data will then be processed as necessary to display the desired information in the GUI display area, such as area 708 in FIGS. 7 and 8. This data collection and processing may be performed under the control of view processing program code.

In one preferred form of the invention, all status information relating to the implementation of operational updates is maintained in a transaction log such as that shown at 508 in FIG. 5 under the control of status storage program code executed by a suitable status controller. For example, in the arrangement shown in FIG. 5, the same data processing system or systems implementing deployment manager 501 may implement the status controller. The status controller may even be considered to be part of deployment manager 501. In this embodiment in which all operational update status information is maintained through a transaction log, collecting the necessary data according to process block 603 in FIG. 6 may include identifying and reading the most recent transaction log entry for each node which represents a target data processing system for an operational update, and the processing may include identifying the status indicated by that log entry. These data collection and processing activities may be performed by or under the control of deployment manager 501 in FIG. 5 or some other process operating at a suitable data processing device having access to the transaction log. Other forms of the present invention may employ status storage program code which is executed to produce and maintain a status data structure separate from an operational update transaction log. This status data structure may be produced by continuously analyzing transaction log entries to maintain status data structure entries showing the current status and other relevant information for each target data processing system that is associated with an operational update. Thus, the data collection and processing indicated at process block 603 in FIG. 6 may at least partially be ongoing and not related to any particular monitoring request generated by the GUI processes. However, even in this continuous processing case, the relevant data in the status data structure will still be identified based on the monitoring request. For example, a monitoring request may specify all operational update items having a “pending” status, and the status data structure will be queried for all items having this “pending” status. Whether the status information store is held in the form of a transaction log or a special status data structure maintained separate from any transaction log, the particular data storage device in which the status information is stored (such as storage device 106 referenced in FIGS. 1 and 5) represents the update status storage device described above in the summary section.

Regardless of how the relevant data is collected and processed as indicated at process block 603 in FIG. 6, the end result of the data collection and processing will be status information representing some subset of the total status that may be stored in a transaction log such as log 508 in FIG. 5 or otherwise for an operational update system. This subset of operational update status information will be displayed through the GUI as indicated at process block 604 in FIG. 6 also under the control of the view processing program code. The display of information may be as shown in area 708 of FIG. 8, or in any other suitable fashion. In any event, the subset of status information will be displayed in a form specified by the user interface process, that is, the processes that implement the GUI (such as GUI 700).

It should be noted that even if the GUI processes according to the present invention generate a monitoring request that specifies “all” operational update items rather than just pending, completed, or error items, the resulting display as indicated at process block 604 will still probably include only a subset of the operational update information stored by or for the operational update system. This is because the stored information will generally include other information that is not displayed through the GUI according to the invention. For example, a transaction log such as transaction log 508 in FIG. 5, which may serve as a data store for status information relating to the implementation of operational updates in the system, will typically include log entry dates and times, log entry identifiers, and other types of information that is not ultimately displayed through a GUI according to the present invention.

The processes indicated at blocks 605, 610, 611, and 612 in FIG. 6 are associated with an arrangement in which a user may modify an operational update item displayed as indicated at process block 604. These processes are all preferably performed under the control of modification program code. The inquiry indicated at decision block 605 in FIG. 6 is used to determine whether any of the displayed items are selected for possible modifications. If an item displayed through the GUI is selected at decision block 605, the process illustrated in FIG. 6 first displays the item in a manner in which a modification may be made as indicated at process block 610. Once the operational update item is displayed in a manner in which it may be modified, the system may receive a modification input as indicated at process block 611. Depending upon the nature of the modification input, the input may result in a modification of a durable subscription associated with the affected target data processing system. This durable subscription modification is shown at process block 612 in FIG. 6. Also after receiving the modification input as shown at process block 611, the process preferably returns to the display of the subset of status information from which the operational update item was earlier selected to prompt the branch at decision block 605. At this point, the user may select another operational update item for potential modification or the process may end if an end GUI input is entered as indicated at decision block 606, or the process may return to wait for another monitoring request if an end GUI input has not been entered.

The invention encompasses any suitable technique for selecting a displayed item for potential modifications which will result in a positive result from the inquiry indicated at decision block 605 in FIG. 6. For example, GUI 700 may be implemented such that a double click with a suitable pointing device on the desired item will select the item. Alternatively, selecting an item may require using a pointing device to click on the item and then invoking an “edit” control available on the GUI (“edit” control not shown in the figures). Such an “edit” control may be selected from a pull-down or pop-up menu of controls that appears on the GUI when an item is “clicked on” using the pointing device. Any number of other selection techniques may be used in accordance with the present invention.

In one preferred form of the invention, the step of displaying the selected item for potential modification as indicated at process block 610 in FIG. 6 may include merely highlighting the selected item, or otherwise showing the item in a special graphical form indicating that the item may be modified. Alternatively, selecting an item for potential modification may cause the display such as that shown at area 708 in FIG. 8 to change to remove all items other than the item selected for potential modification. In any case, the display step shown at process block 610 in FIG. 6 may include information in addition to that shown for the respective item as indicated in FIG. 8. For example, the information associated with the “value” label (703 in FIGS. 7 and 8) may be expanded to give the user more options to modify the target indicated under the “value” label. Also, the display may include a dialog box or other GUI feature that gives the user acceptable alternatives for the target identified under the “value” label for the given item. As another example, the information associated with the “node” value may be expanded to assist the user in making the desired modification. Continuing with this example, a pull-down menu or pop-up menu may be displayed to allow the user to select a different node, or a dialog box may be displayed to allow the user to manually enter a different node.

The invention encompasses any way in which a selected item may be modified and any way in which the modification may be specified (input) through the GUI as it may occur to one skilled in the art. For example, the modification input received as indicated at process block 611 in FIG. 6 may be a new target file typed into the location under the “value” label for the given item, or a new target file selected from a menu or file folder construct. As another example, the modification input received as indicated at process block 611 may be a new node identifier typed into the area under the “node” label for the selected item, or a new node identifier selected from a menu. Also, a modification input according to the invention may comprise a “copy” input that allows the user to copy the item and then modify it as necessary, to specify a new node on the network for example.

In the event some modification is entered as indicated at process block 611 in FIG. 6, the modification may affect a durable subscription for the target data processing system associated with the modified item. Thus, the durable subscription for the target data processing system may be modified as indicated at process block 612 in FIG. 6. It will be appreciated that some modifications that may be made in the system may not result in a modification to a durable subscription. Also, it may be desirable that certain modifications are prevented from modifying the durable subscription for the data processing system associated with the modified item. In this latter case, the user may enter a command or invoke some control along with the modification input entered at process block 611 which directs that the durable subscription is not to be modified even in view of the modification. In any event, it will be appreciated that the durable subscription modification step shown at process block 612 is preferably implemented by suitable program code that interfaces with the durable subscription information for the update system such as information 506 shown in FIG. 5, to update the durable subscription information as necessary.

It is important to note that while the present invention has been described in the context of one or more fully functioning data processing systems, those of ordinary skill in the art will appreciate that the computer program code that may be executed to implement the various processes according to the invention is capable of being distributed through any suitable computer readable medium. Examples of computer readable media in which program code according to the invention may be embodied include recordable-type media, such as a floppy disk, a hard disk drive, a RAM, CD-ROMs, DVD-ROMs, and transmission-type media, such as wired or wireless communications links (analog or digital) using transmission forms, such as, for example, radio frequency and light wave transmissions. The computer readable media may take the form of coded formats that are decoded for actual use in a particular data processing system.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, August 2001 as revised May 2004), Section 2111.03.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the invention.

1. A method including:
(a) storing status information relating to implementation of operational updates for respective data processing systems in a network that includes a number of data processing systems;
(b) receiving a monitoring request generated by a user interface process, the monitoring request specifying a subset of the status information; and
(c) in response to the monitoring request, collecting the subset of the status information and displaying the subset of the status information at a display device in a form specified by the user interface process.

2. The method of claim 1 wherein storing the status information includes maintaining a log of actions relating to the implementation of the operational updates.

3. The method of claim 1 wherein the monitoring request includes a status value which limits the subset of the status information to status information related to the status value.

4. The method of claim 3 wherein the monitoring request also includes a filter value which limits the subset of status information to status information that passes the filter value.

5. The method of claim 1 wherein the monitoring request includes a filter value which limits the subset of status information to status information that passes the filter value.

6. The method of claim 1 further including generating the monitoring request in connection with the start up of the user interface process.

7. The method of claim 1 further including generating the monitoring request in response to a user input received through the user interface process.

8. The method of claim 1 further including:
(a) receiving an entry selection input through the user interface process, the entry selection input specifying an operational update item for a respective one of the data processing devices included in the network;
(b) receiving a modification input through the user interface process, the modification input specifying a modification to an aspect of the operational update item specified by the entry selection input; and
(c) modifying the specified operational update item according to the modification specified by the modification input.

9. The method of claim 8 further including modifying a durable subscription for the respective one of the data processing systems for which the operational update item was specified by the entry selection input, the durable subscription being modified in accordance with the modification specified by the modification input.

10. An apparatus including:
(a) an update status storage device storing status information relating to implementation of operational updates for respective data processing systems in a network that includes a number of data processing systems; and
(b) a user interface system for (i) generating a monitoring request which specifies a subset of the status information, for (ii) collecting the subset of the status information from the update status storage device, and for (iii) causing the subset of the status information to be displayed at a display device associated with the user interface system.

11. The apparatus of claim 10 further including a status controller for receiving information on status affecting actions and for causing the update status storage device to store the information on the status affecting actions as part of the status information.

12. The apparatus of claim 11 wherein the status controller causes the update status storage device to store a log of status affecting actions.

13. The apparatus of claim 10 wherein the user interface system includes a server component remote from the display device.

14. The apparatus of claim 13 wherein the user interface system includes a client component at the location of the display device.

15. The apparatus of claim 10 further including a modification controller for making a modification to an aspect of a pending operational update.

16. A program product embodied in computer readable form, the program product including:
(a) status storage program code executable for causing status information to be stored in a data storage device, the status information relating to implementation of operational updates for respective data processing systems in a network that includes a number of data processing systems;
(b) user input program code executable for generating a monitoring request which specifies a subset of the status information; and
(c) view processing program code executable for collecting the subset of the status information specified in the monitoring request, and for causing the subset of the status information to be displayed at a display device.

17. The program product of claim 16 wherein the status storage program code causes a log of status affecting actions to be stored in the data storage device, each status affecting action relating to the implementation of a respective one of the operational updates.

18. The program product of claim 16 wherein the view processing program code limits the subset of the status information to status information related to a status value included in the monitoring request.

19. The program product of claim 16 wherein the view processing program code limits the subset of the status information to status information which passes a filter value.

20. The program product of claim 16 further including modification program code executable for producing a modification to a pending operational update.
